(19) United States
(12) Patent Application Publication
(10) Pub. No.: US 2002/0080936 A1
(43) Pub. Date: Jun. 27, 2002

(54) Telecommunications devices utilizing a 10 key tel keypad design

(76) Inventor: Mokhtar Shawky, Orange, CA (US)

Correspondence Address: Roy L. Anderson, Esq., Jeffers, Shaff & Falk, LLP, Suite 1400, 18881 Von Karman Ave., Irvine, CA, 92612, US

(21) Appl. No.: 09/962,976

(22) Filed: Sep. 25, 2001

Related U.S. Application Data
(60) Provisional application No. 60/234,782, filed on Sep. 25, 2000.

(51) Int. Cl. H04M 11/00; H04B 1/00

(52) U.S. Cl. 379/93.27; 379/110.01

(57) ABSTRACT

A telephone or computer keyboard is equipped with a twelve key keypad configured to correspond to a standard telephone keypad output when their input is based upon a financial keypad format.

### CROSS REFERENCE TO RELATED APPLICATIONS

The present invention is a continuation-in-part of U.S. provisional patent application No. 60/234,782 filed Sep. 25, 2000, the disclosure of which is incorporated herein by reference.

### FIELD OF THE INVENTION

The present invention is in the field of telecommunication devices having a keypad.

### BACKGROUND OF THE INVENTION

Over thirty years ago, all telephone devices used a rotary dialing system. As technology changed, the telephone industry changed the dialing function from using a rotary device to the current push button device. When the change was made, the telephone industry came up with a keypad design that uses twelve keys arranged in four rows of three columns, the first row being 1, 2, 3, the second row being 4, 5, 6, the third row being 7, 8, 9, and the fourth row being *, 0, #. An example of this keypad design, which will be referred to as a “standard telephone keypad,” is shown in FIG. 1. The standard telephone keypad shown in FIG. 1 has been adopted as an industry-wide standard worldwide and has been used in hundreds of millions of telephones and facsimile devices.

While most consumers and telephone users would never give the standard telephone keypad a second thought, it can create confusion for a limited, but somewhat large, subset of consumers who use a different standard keypad design that will be referred to as a “standard financial keypad.” The standard financial keypad uses eleven keys arranged in three rows of three columns, the first row being 7, 8, 9, the second row being 4, 5, 6, and the third row being 1, 2, 3, plus a fourth row in which the first and second columns are combined into a single 0 key that is twice the size of the other keys, plus an eleventh key that is used as a period. An example of the standard financial keypad is shown in FIG. 2.

The standard financial keypad is used in calculators, accounting machines, computers and other business machines that are used by accountants, auditors, financial professionals, office clerks, data entry clerks, cash register operators, technicians, computer operators, and others on a daily basis. Such persons often use the standard financial keypad all day long while they are working, sometimes in hundreds or even thousands of transactions a day, and it is not uncommon for such persons to be so familiar with the keypad that its use becomes second nature and they use it without looking, in much the same way as persons proficient in typing do not need to look at a typing keyboard.

The differences between the two different standard keypad designs can lead to numerous mistakes due to incorrect entry of keys, not because of a mistake in hitting the wrong key in the traditional sense (for example, punching a 4 or an 8 instead of a 7), but because the right key was hit, but for the wrong keypad (for example, punching a 1 instead of a 7 because a 1 is found in the same place on the standard telephone keypad that a 7 is found on the standard financial keypad). Misdialing of telephone numbers can cause a great deal of frustration, while also causing individuals and organizations to lose time and money, especially when an individual is switching between a telephone or facsimile machine while working with a device that uses the standard financial keypad. Moreover, the same problem represents a special hardship for vision impaired and handicapped individuals.

As one might expect, the problems associated with misdialed phone numbers due to differences between the standard telephone and financial keypads have not gone unnoticed.

In U.S. Pat. No. 4,382,162, issued to Metz, a telephone attachment is disclosed that is placed over a standard telephone keypad. The attachment contains a series of levers that are arranged so that when the keys of the attachment are pressed they will activate the underlying keys in such an order that the combination of the attachment and the underlying keys will convert the standard telephone keypad of the telephone (which has been covered by the attachment) into a standard financial keypad. While this attachment represents a significant advance and is an attempt to address problems associated with the differences between the two standard keypads, it suffers from the problem of being a patchwork solution. In other words, it does not address the core, underlying problem associated with the standard telephone keypad. Moreover, the attachment must be designed to fit a particular phone, so it is a rather expensive and bulky way to deal with the underlying problem.

### SUMMARY OF THE INVENTION

The present invention is generally directed to a telephone having a housing and a keypad with twelve keys incorporated into the housing that are connected so that their output will correspond to a standard telephone keypad output when their input is based upon a financial keypad format. The telephone can be incorporated into a telecommunication, such as a facsimile machine, or the twelve key keypad with a financial keypad format can be incorporated into a computer keyboard.

Accordingly, it is a primary object of the present invention to provide a twelve-key financial keypad format in keypads used in telecommunications devices.

This and further objects and advantages will be apparent to those skilled in the art in connection with the drawings and the detailed description of the preferred embodiment set forth below.

### BRIEF DESCRIPTION OF THE DRAWINGS

FIG. 1 is a diagrammatic representation of a prior art telephone with a standard telephone keypad.

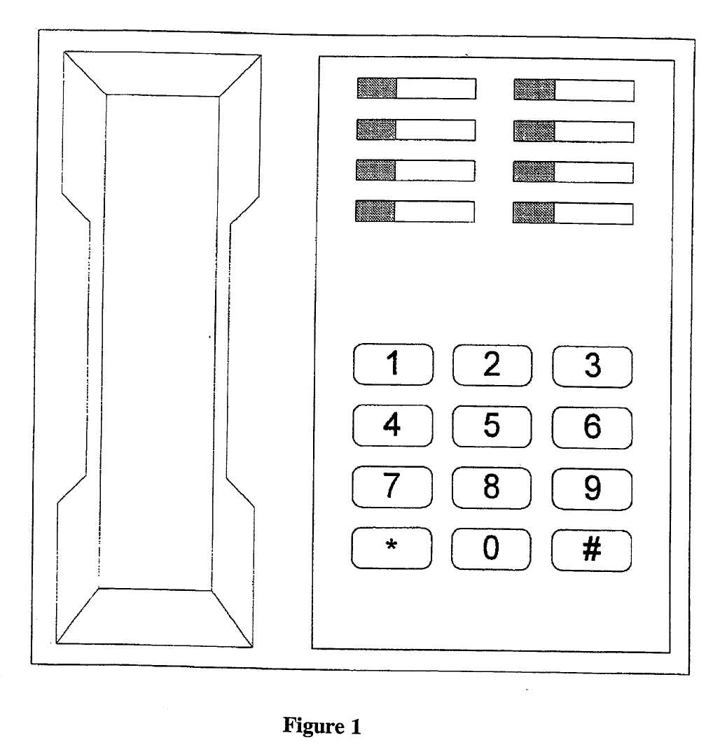

FIG. 2 is a diagrammatic representation of a standard financial keypad.

FIG. 3 is a diagrammatic representation of a telephone with a standard financial keypad in accordance with the present invention.

### DETAILED DESCRIPTION OF THE PREFERRED EMBODIMENT

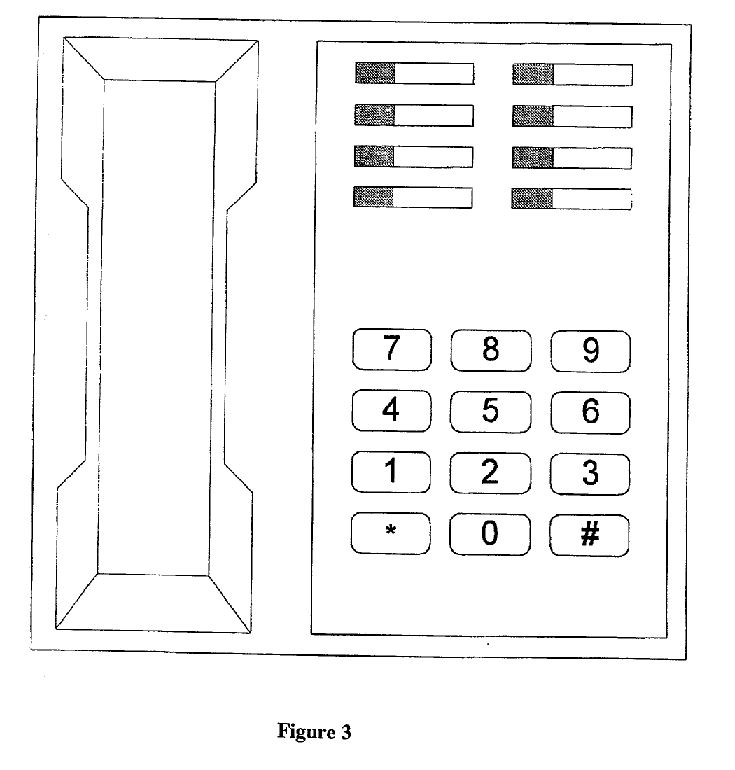

In accordance with a preferred embodiment of the present invention, a standard telecommunication device, such as a telephone, is equipped with a keypad that is not connected according to the format of a standard telephone keypad but, rather, connected such that four rows of three keys will generate the following rows of input, moving from left to right and top to bottom: 7, 8, 9; 4, 5, 6; 1, 2, 3; and *, 0, #. Such a keypad is shown in FIG. 3 and will hereinafter be referred to as a keypad having a financial keypad format (the difference between this format and the standard financial keypad being in the fourth row.) In all other details, the telecommunication device functions the same as a standard telecommunication device in use today. Thus, for example, the telecommunication device will have a housing, and the keypad will be incorporated into and the housing and be an integral part of the device.

Unlike some other devices that have been proposed in the prior art, such as in U.S. Pat. No. 5,375,165 or U.S. Pat. No. 6,009,164, the present invention is not directed to a new type of keypad device incorporated in something that might change the function of the keys, or be a removable keypad. Nor is the present invention interested in creating an entirely new keypad that does not follow the standard keypad format of four rows of three keys such as is disclosed in U.S. Pat. No. 6,137,426. Instead, the goal of the present invention is to completely replace a standard telephone keypad with a keypad having a financial keypad format as part of the manufacturing process so as to offer a new alternative to convention telecommunication devices.

Because the present invention is directed to a telephone or telecommunication device in which a standard telephone keypad is replaced with a keypad having a financial keypad format as part of the manufacture of the device, the keypad having a financial keypad format will generate dial tones in the same manner as conventional telecommunication technology, the only difference being the arrangement of the location of the keys. While a printed circuit board could be designed for specific use with such a keypad, the telephone could rely upon prior technology, such as is described in U.S. Pat. No. 3,617,936, the disclosure of which is specifically incorporated herein by reference, so that it need not use a specially designed printed circuit board. In whichever option is used, the result will be the same, namely, that the order of the keys needed to arrive at the same dialing format will be different, but otherwise the same dialing format will be achieved.

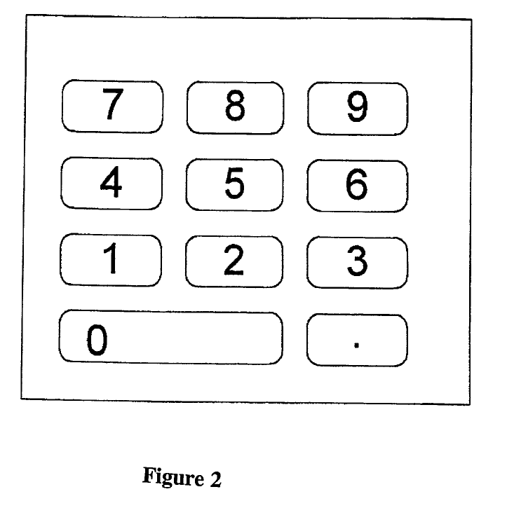

In an alternative preferred embodiment of the present invention, a keypad having a financial keypad format is incorporated into a computer keypad. In this alternative embodiment, the twelve key keypad is used instead of the eleven key keypad typically found in keyboards, such as those disclosed in FIGS. 2 and 3 of U.S. Pat. No. 5,252,940.

While I have disclosed a specific embodiment of my invention, it will be understood that this is for the purpose of illustration only, and that additional embodiments thereof and further modifications may be obvious to those skilled in the art with the aid of this disclosure without departing from the inventive concept described herein. Accordingly, my invention is not intended to be limited except as is required by the lawful scope of the following claims.

What is claimed is:

1. A telephone having a housing and a keypad with twelve keys incorporated into the housing, the improvement of which comprises connecting the twelve keys so that their output will correspond to a standard telephone keypad output when their input is based upon a financial keypad format.

2. A telephone as recited in claim 1, wherein the telephone is incorporated into a telecommunication device.

3. A telephone as recited in claim 2, wherein the telecommunication device is a facsimile machine.

4. A computer keyboard, the improvement of which comprises incorporating a twelve key keypad with a financial keypad format into the keyboard.
